(19) United States
(12) Patent Application Publication
(10) Pub. No.: US 2008/0102820 A1
(43) Pub. Date: May 1, 2008

(54) SYSTEM AND METHOD FOR PROCESSING CONNECTION REQUESTS IN A MOBILE TERMINAL

(75) Inventor: Tzu Chien Chang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/554,633

(22) Filed: Oct. 31, 2006

(51) Int. Cl. H04Q 7/20

(52) U.S. Cl. 455/425

(57) ABSTRACT

A mobile terminal is provided. The mobile terminal comprises a communication unit and a controller. The communication unit receives a connection request. The controller checks whether a call-receiving function of the mobile terminal has been disabled, and if so, processes the connection request without completing RR (radio resource), MM (mobility management), or CC/SS/SMS (call control/supplemental service/short message service) connections.

### BACKGROUND

The invention relates to mobile communication technology, and more particularly to a method and system for blocking incoming calls and messages in a mobile communication terminal.

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Conventionally, to reject an incoming call, one can choose not to answer the phone and keep it ringing. Similarly, a message, once transmitted to a subscriber mobile phone, cannot be blocked or received based on user preference. For example, a subscriber when abroad, may not want to receive calls or messages, but may want to place calls. In the described scenario, incoming calls and messages from the home country of the user cannot be blocked while simultaneously maintaining the ability to place calls.

According to another conventional method, a “blacklist” may be established to block an incoming call from a particular caller. In this case, when an incoming call sending from a caller specified in the blacklist is received, the subscriber mobile phone blocks the incoming call. Here, the blocking mechanism is implemented in an upper connection layer. In other words, before further blocking the call, the subscriber mobile phone still completes the establishments of radio RR (radio resource), MM (mobility management), and CC/SS/SMS (call control/supplemental service/short message service) connection upon receiving the incoming call. Generally, while blocking, a message indicating that the subscriber mobile phone is now busy will be presented to the caller who sent the blocked incoming call.

According to another conventional method, a “fly mode” is used to block an incoming call. When the fly mode is activated, all incoming calls are blocked, and at the same time no outgoing call can be placed, too. In other words, under the fly mode, all applications on the subscriber mobile phone requiring establishing a connection will be banned.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A method of processing a connection request in a mobile terminal is provided. The connection request is received. It is determined whether a call-receiving function of the mobile terminal has been disabled. When the call-receiving function of the mobile terminal has been disabled, the connection request is processed without completing radio RR (radio resource), MM (mobility management), or CC/SS/SMS (call control/supplemental service/short message service) connections.

A method of processing a connection request in a mobile terminal is provided. The connection request is received. It is determined whether a call-receiving function of the mobile terminal has been disabled. When the call-receiving function of the mobile terminal has been disabled, the connection request is processed without completing CC/SS/SMS (call control/supplemental service/short message service) connection.

A mobile terminal is provided. The mobile terminal comprises a communication unit and a controller. The communication unit receives a connection request. The controller checks whether a call-receiving function of the mobile terminal has been disabled, and if so, processes the connection request without completing RR (radio resource), MM (mobility management), or CC/SS/SMS (call control/supplemental service/short message service) connections.

A mobile terminal is provided. The mobile terminal comprises a communication unit and a controller. The communication unit receives the connection request. The controller checks whether a call-receiving function of the mobile terminal has been disabled, and if so, processes the connection request without completing CC/SS/SMS (call control/supplemental service/short message service) connection.

### BRIEF DESCRIPTION OF DRAWINGS

The invention can be more fully understood by reading the subsequent detailed description and examples with references made to the accompanying drawings, wherein:

FIG. 1 is a block diagram of an embodiment of a mobile terminal;

FIGS. 2A˜2C are flowcharts of embodiments of a method of processing a connection request;

FIG. 3 illustrates an embodiment of a method for establishing a connection; and

FIG. 4 is a schematic view of protocol architecture of GSM network system.

### DETAILED DESCRIPTION OF INVENTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve the specific goals of the developer, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

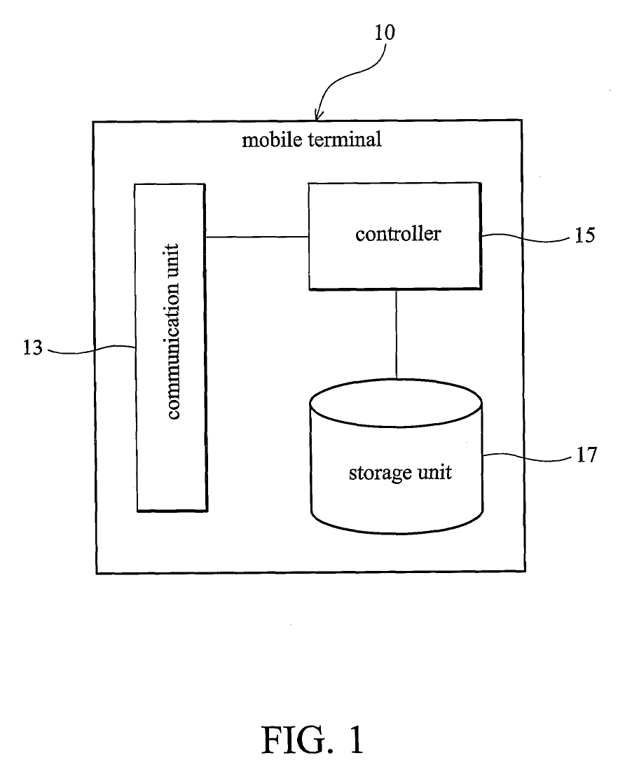

The invention is now described with reference to FIGS. 1 through 4, which generally relate to mobile communication. In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

In the invention, the call-receiving function of a mobile terminal can be configured according to user preference. By enabling or disabling the call-receiving function for connection requests, users can determine whether to establish a connection or not. For example, when a user wants to maintain the ability of a mobile terminal to place calls, without receiving incoming calls, the user can disable the call-receiving function.

In the invention, call-receiving function may be applications triggered by an incoming call or incoming message. The call-receiving function can be disabled by not completing any of RR (radio resource) connection, MM (mobility management) connection, and CC/SS/SMS (call control/supplemental service/short message service) connection. The subscriber mobile phone blocks an incoming call indicating a caller sending the incoming call that the subscriber mobile phone cannot be reached. On the contrary, when blocking an incoming call, the blacklist mechanism indicates that the subscriber mobile phone is busy. In addition, according to the invention, only call-receiving function is disabled to block incoming calls, and a user can place a call and use other functions of the mobile phone. On the contrary, the fly mode mechanism disables both the call-receiving and call-placing function of the mobile phone, and thus inconvenience is incurred.

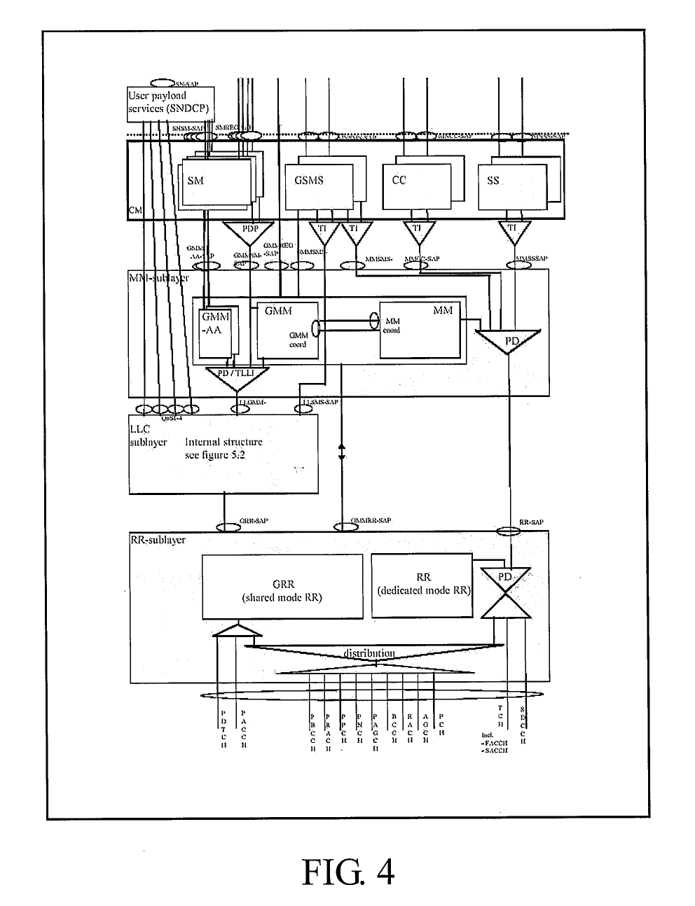

It should be noted that the invention is applicable to mobile terminals capable of processing a connection request, such as mobile phones, smart phones, PDAs, and similar, via a communication network. The communication network can be the GSM (Global System for Mobile communications), the GPRS (General Packet Radio Service), the CDMA (Code Division Multiple Access), or the UMA (Unlicensed Mobile Access) communication system. Referring to FIG. 4, a schematic view of protocol architecture of GSM network system is illustrated.

The method and system of the invention will be described in detail in the following.

Here, a mobile terminal operating in a GSM communication system is given as an example. FIG. 1 is a block diagram of an embodiment of a mobile terminal. Referring to FIG. 1, a mobile terminal 10 comprises a communication unit 13, a controller 15, and a storage unit 17. The communication unit 13 receives a connection request. For example, the communication unit 13 receives a connection request, specified as a page request in GSM standard, wherein the connection request indicates a request for a connection for an incoming call or an incoming message to be established.

The controller 15 sets a flag in the storage unit 17 to disable or enable the call-receiving function of the mobile terminal 10. The controller 15 checks whether a call-receiving function of the mobile terminal 10 has been disabled, and if the call-receiving function of the mobile terminal 10 has been disabled, processes the connection request without completing RR (radio resource), MM (mobility management), or CC/SS/SMS (call control/supplemental service/short message service) connections. The controller 15, may, for example process the connection request without completing a CC/SS/SMS connection. In another example, if the call-receiving function of the mobile terminal has been disabled, the controller 15 processes the connection request by not completing CC/SS/SMS or MM (mobility management) connections. In a third example, if the receiving function of the mobile terminal has been disabled, the controller 15 processes the communication request by not completing CC/SS/SMS (call control/supplemental service/short message service), MM (mobility management), or RR (radio resource) connections.

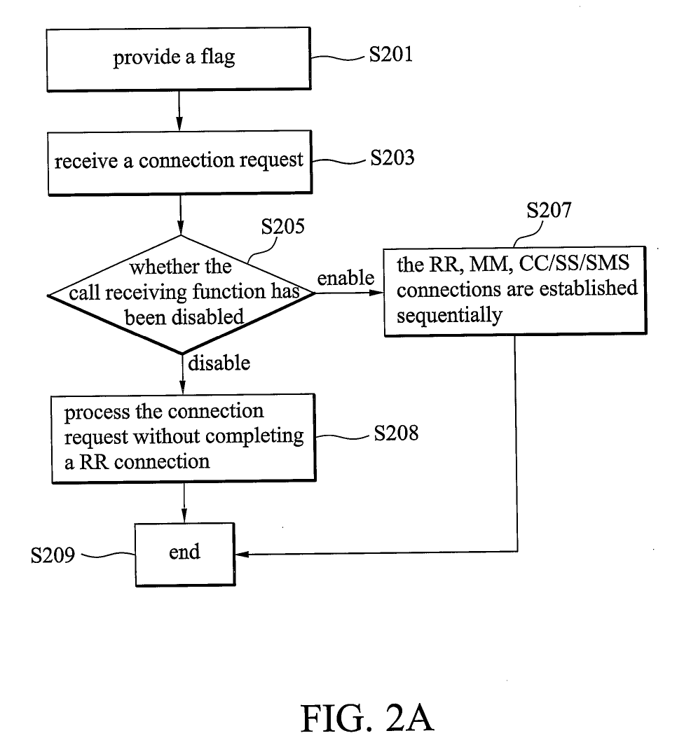

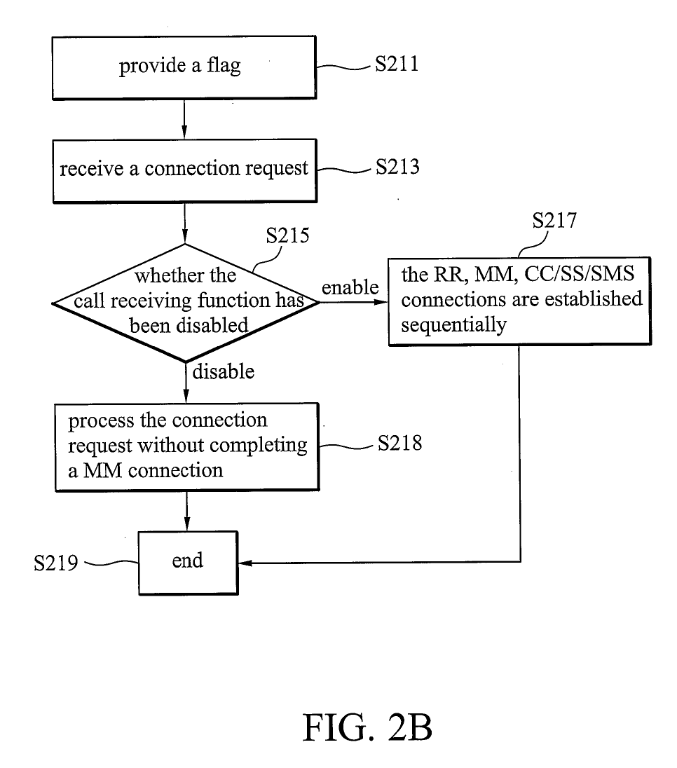

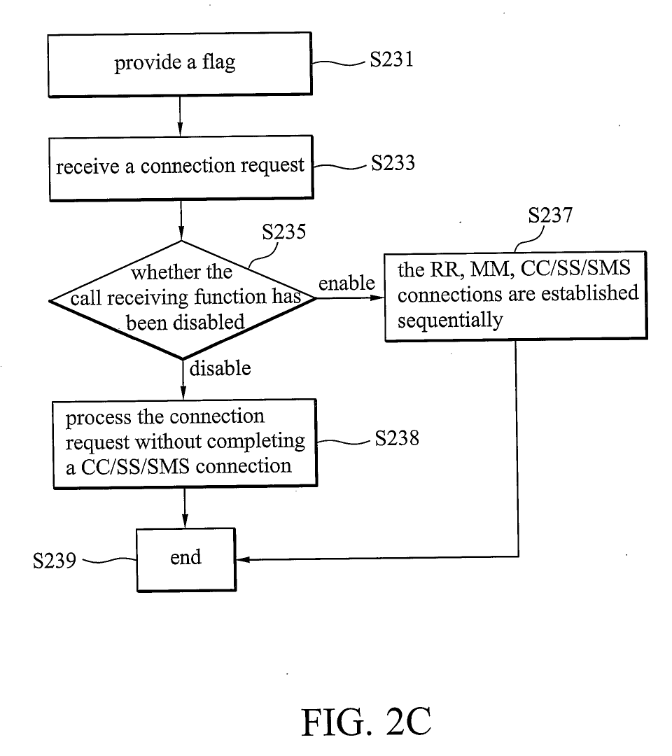

FIG. 2A illustrates a first embodiment of a method for processing a connection request. The method illustrated in FIG. 2A can be implemented in the mobile terminal of FIG. 1. FIG. 2A is a flowchart showing the operation of temporarily disabling a call/message receiving function in a mobile terminal. In step S201, a flag is provided in the storage device of the mobile terminal, specifying whether the call receiving function of the mobile terminal has been disabled. In step S203, a connection request, such as GSM standard specified paging request, is received. In step S205, it is determined whether the call receiving function has been disabled, and if so, the method proceeds to step S208, and otherwise, to step S207. In step S208, the connection request is processed, and the method proceeds to an end (step S209) without completing a RR connection according to the received connection request. In step S207, the RR (radio resource), MM (mobility management), CC/SS/SMS (call control/supplemental service/short message service) connections are established sequentially in response to the received connection request.

FIG. 2B illustrates a second embodiment of a method for processing a connection request. The method illustrated in FIG. 2B can be implemented in the mobile terminal of FIG. 1. FIG. 2B is a flowchart showing the operation of temporarily disabling a call/message receiving function in a mobile terminal. In step S211, a flag, specifying whether the call receiving function of the mobile terminal has been disabled, is provided in the storage device of the mobile terminal. In step S213, a connection request, such as the GSM standard specified paging request, is received. In step S215, it is determined whether the call receiving function has been disabled, and if so, the method proceeds to step S218, otherwise, to step S217. In step S218, the connection request is processed, and the method proceeds to an end (step S219) without completing an MM connection according to the received connection request. In step S217, the RR (radio resource), MM (mobility management), CC/SS/SMS (call control/supplemental service/short message service) connections are established sequentially in response to the received connection request.

Referring to FIG. 2C, another embodiment of a method of processing a connection request is illustrated. The method illustrated in FIG. 2C can be implemented in the mobile terminal of FIG. 1. FIG. 2C is a flowchart showing the operation of temporarily disabling a call/message receiving function in a mobile terminal. In step S231, a flag is provided in the storage device of the mobile terminal, specifying whether the call receiving function of the mobile terminal has been disabled. In step S233, a connection request, such as the GSM standard specified paging request, is received. In step S235, it is determined whether the call receiving function has been disabled, and if so, the method proceeds to step S238, otherwise, to step S237. In step S238, the connection request is processed, and the method proceeds to an end (step S239) without completing a CC/SS/SMS connection according to the received connection request. In step S237, the RR (radio resource), MM (mobility management), CC/SS/SMS (call control/supplemental service/short message service) connections are established sequentially in response to the received connection request.

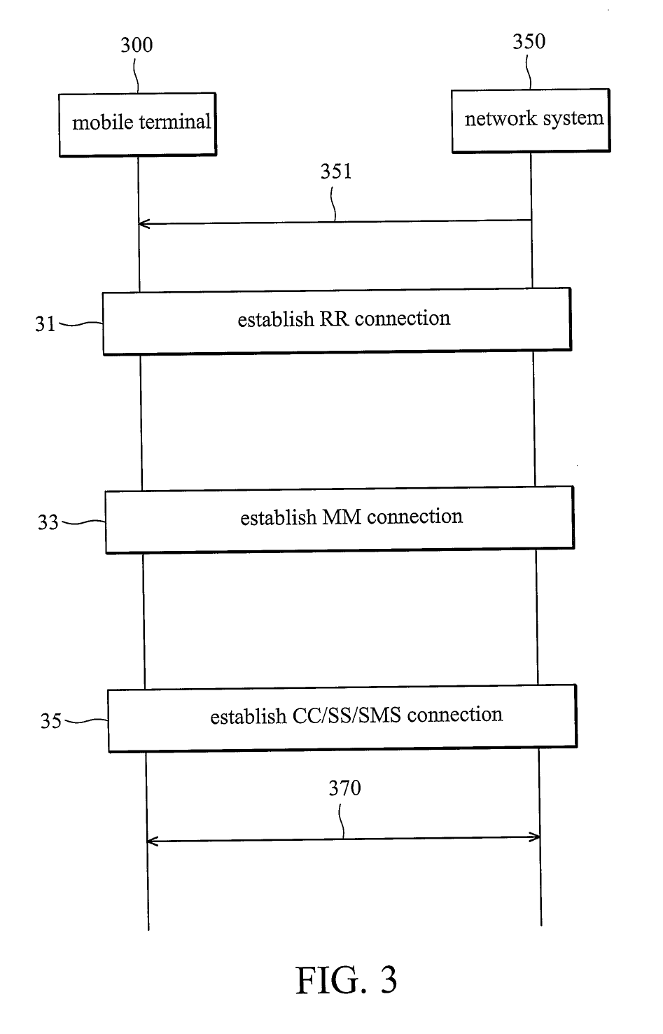

FIG. 3 illustrates an embodiment of a method for establishing a connection. Here, a mobile terminal 300 and a network system 350 communicate according to a GSM standard. It should be noted that GPRS (General Packet Radio Service), CDMA (Code Division Multiple Access), and UMA (Unlicensed Mobile Access) communication systems may also be implemented.

When an incoming call or message directed to mobile terminal 300 is present, network system 350 transmits a paging request 351 to mobile terminal 300. If call receiving function is enabled, the mobile terminal 300 performs procedures 31, 33, and 35 to establish RR (radio resource), MM (mobility management), CC/SS/SMS (call control/supplemental service/short message service) connections sequentially, and connection 370 is then established thereby. If the call receiving function is disabled, the mobile terminal 300 does not perform procedures 31, 33, and 35, thus a connection establishment is not completed, and the connection 370 is not established. For example, if the call receiving function is disabled, mobile terminal 300 can ignore the paging request, and no RR (radio resource), MM (mobility management), CC/SS/SMS (call control/supplemental service/short message service) connections are established. In another example, mobile terminal 300 establishes the RR connection (procedure 31) but not MM, or CC/SS/SMS connections (procedures 33 and 35). In still another example, the mobile terminal 300 establish the RR and MM connections, but not the CC/SS/SMS connection.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of processing a connection request in a mobile terminal, comprising:
receiving the connection request;
checking whether a call-receiving function of the mobile terminal has been disabled; and
if the call-receiving function of the mobile terminal has been disabled, the connection request is processed without completing any of a radio RR (radio resource), MM (mobility management), and CC/SS/SMS (call control/supplemental service/short message service) connection.

2. The method of claim 1, wherein the connection request is a paging request conforming to GSM standard.

3. The method of claim 1, wherein the connection request requires a connection to be established for an incoming call.

4. The method of claim 1, wherein the communication request requires a connection to be established for an incoming message.

5. The method of claim 1, further setting a flag to disable or enable the call-receiving function of the mobile terminal.

6. A method of processing a connection request in a mobile terminal, comprising:
receiving the connection request;
determining whether a call-receiving function of the mobile terminal has been disabled; and
if the call-receiving function of the mobile terminal has been disabled, the connection request is processed without completing CC/SS/SMS (call control/supplemental service/short message service) connection.

7. The method of claim 6, further comprising, if the call-receiving function of the mobile terminal has been disabled, processing the connection request by completing neither CC/SS/SMS connection nor MM (mobility management) connection.

8. The method of claim 6, further comprising, if the receiving function of the mobile terminal has been disabled, processing the communication request by completing neither CC/SS/SMS (call control/supplemental service/short message service) connection, MM (mobility management) connection, nor RR (radio resource) connection.

9. The method of claim 6, wherein the connection request is a paging request specified conforming to GSM standard.

10. The method of claim 6, wherein the connection request requires a connection to be established for an incoming call.

11. The method of claim 6, wherein the connection request requires a connection to be established for an incoming message.

12. The method of claim 6, further setting a flag to disable or enable the call-receiving function of the mobile terminal.

13. A mobile terminal, comprising:
a communication unit receiving a connection request; and
a controller determining whether a call-receiving function of the mobile terminal has been disabled, and if so, processing the connection request without completing any of a RR (radio resource), MM (mobility management), and CC/SS/SMS (call control/supplemental service/short message service) connection.

14. The mobile terminal of claim 13, wherein the communication unit receives the connection request as a paging request conforming to the GSM standard.

15. The mobile terminal of claim 13, wherein the communication unit receives the connection request requiring a connection for an incoming call to be established.

16. The mobile terminal of claim 13, wherein the communication unit receives the communication request requiring a connection to be established for an incoming message.

17. The mobile terminal of claim 13, further comprising a storage unit, wherein the controller further sets a flag in the storage unit to disable or enable the call-receiving function of the mobile terminal.

18. A mobile terminal, comprising:
a communication unit receiving a connection request; and
a controller determining whether a call-receiving function of the mobile terminal has been disabled, and if so, processing the connection request without completing CC/SS/SMS (call control/supplemental service/short message service) connection.

19. The mobile terminal of claim 18, if the call-receiving function of the mobile terminal has been disabled, the controller processes the connection request by completing neither CC/SS/SMS connection nor MM (mobility management) connection.

20. The mobile terminal of claim 18, if the receiving function of the mobile terminal has been disabled, the controller processes the communication request by completing neither CC/SS/SMS (call control/supplemental service/short message service) connection, MM (mobility management) connection, nor RR (radio resource) connection.

21. The mobile terminal of claim 18, wherein the communication unit receives the connection request specified as a paging request conforming to GSM standard.

22. The mobile terminal of claim 18, wherein the communication unit receives the connection request requiring a connection to be established for an incoming call.

23. The mobile terminal of claim 18, wherein the communication unit receives the connection request requiring a connection to be established for an incoming message.

24. The mobile terminal of claim 18, further comprising a storage unit, wherein the controller further sets a flag in the storage unit to disable or enable the call-receiving function of the mobile terminal.
